(19) United States
(12) Patent Application Publication
(10) Pub. No.: US 2008/0159752 A1
(43) Pub. Date: Jul. 3, 2008

(54) FIBER OPTICAL COMMUNICATIONS SYSTEMS EMPLOYING PHASE INCOHERENT SOURCES

(75) Inventor: Weiguo Yang, East Windsor, NJ (US)

Correspondence Address: PATTERSON & SHERIDAN, LLP/;LUCENT TECHNOLOGIES, INC, 595 SHREWSBURY AVENUE, SHREWSBURY, NJ, 07702, US

(73) Assignee: LUCENT TECHNOLOGIES INC.

(21) Appl. No.: 11/619,419

(22) Filed: Jan. 3, 2007

(51) Int. Cl. H04B 10/12; H04B 10/04

(52) U.S. Cl. 398/186

(57) ABSTRACT

The invention includes a transmitter and transmission method for reducing inter-symbol interference (ISI) related to fiber nonlinearity and dispersion in a fiber optic communication system, such as a high bit rate, long haul optical communications system. A data modulated phase incoherent, low intensity noise optical signal exhibits reduced ISI at the expense of increased, though more easily corrected, random intensity noise a timing jitter errors.

### FIELD OF THE INVENTION

The invention relates to fiber optic communication systems generally and, more particularly, to reducing inter-symbol interference (ISI) related to fiber nonlinearity and dispersion effects.

### BACKGROUND OF THE INVENTION

One major problem associated with current fiber optical communication systems is related to optical fiber dispersion and nonlinearity. Specifically, dispersion spreads optical energy into adjacent bits, causing inter-symbol interferences (ISI). This is because current (typically coherent phase light sources) performance degradation is related to both coherent addition (beating ISI) and incoherent addition (additive ISI). For example, nonlinear distortions adds coherently to the signal or current bit for highly phase coherent laser sources. An example of such nonlinear distortion is the optical energy transferred to a signal channel or bit slot from other signal channels or bit slots by nonlinear effects such as four-wave mixing (FWM). Moreover, the dispersion and the nonlinear distortions are strongly coupled again by the long coherent time of the laser source used, which introduces intractable performance degradation in terms of both pattern dependent amplitude and timing distortions. These distortions/errors are very difficult to be compensated, for example, by dispersion compensation or linear filter based equalizers.

### SUMMARY OF THE INVENTION

Various deficiencies in the prior art are addressed through the invention of a transmitter and transmission method for reducing inter-symbol interference (ISI) related to fiber nonlinearity and dispersion in a fiber optic communication system, such as a high bit rate, long haul optical communications system.

The transmitter includes a modulator, for intensity modulating a phase incoherent, low intensity noise optical signal according to a data stream to produce a modulated optical signal, whereby the modulated optical signal exhibits random intensity noise errors and timing jitter errors when propagated through a long haul optical transmission medium. Receiver circuitry in the long haul transmission system is adapted to correct the random intensity noise errors and timing jitter errors.

### BRIEF DESCRIPTION OF THE DRAWINGS

The teachings of the present invention can be readily understood by considering the following detailed description in conjunction with the accompanying drawings, in which:

FIG. 1 depicts a block diagram of an exemplary embodiment of an optical communications system in accordance with the invention; and

FIG. 2 graphically depicts electrical fields associated with thermal-like light, normal (coherent) laser light, and chaotic laser light.

To facilitate understanding, identical reference numerals have been used, where possible, to designate identical elements that are common to the figures.

### DETAILED DESCRIPTION OF THE INVENTION

Part of the invention lies in the inventor's recognition that some non-linear effects (e.g., non-linear errors and/or dispersion errors) within an optical fiber may be reduced by modifying optical transmitter behavior, though at the expense of increasing other types of errors. However, where the other types of errors are easier to address than the non-linear errors, the overall cost and/or performance parameters of an optical communication system may be improved.

The present invention is discussed in the context of an optical communication system in which the problem of inter-symbol interference (ISI) related to fiber nonlinearity and dispersion is a dominant error source. The invention utilizes a phase incoherent light source to reduce nonlinear ISI impairments at the expense of increased random intensity noise and/or timing jitter impairments. The invention further utilizes a mechanism adapted to reduce these increased impairments. Thus, the relatively more difficult to solve problem of nonlinear ISI impairment is redefined as the relatively less difficult to solve problem of random intensity noise and/or timing jitter impairments.

The inventor recognized that a number of the major impediments in current fiber optical communications systems can be significantly reduced if the optical source used is phase incoherent so that additive ISI dominates over multiplicative or beating ISI. More importantly, in a fiber optic communications systems using a phase incoherent light source, the nonlinear effect from four-wave mixing (FWM) terms gives only amplitude noise, the effect from self-phase modulation and cross-phase modulations terms gives only timing jitter, and the interplay between dispersion and nonlinear effects are decoupled. This is understood by realizing that nonlinear impediments in optical fiber come from nonlinear polarization terms like χE₁E₂E₃ (wave mixing terms) and χ|E₁|²E₂ (nonlinear phase terms).

For phase incoherent light sources, nonlinear wave mixing terms will average to zero field due to lack of coherence between the fields, only contributing the square variation of the field, which exhibits as an additive intensity noise term. On the other hand, the nonlinear phase terms will only contribute to timing jitter. Furthermore, the noise spectrum of the timing jitter is mostly significant at high frequencies. Thus, in one embodiment of the invention, a bandwidth limited modulation format is used so that a major portion of the noise due to timing jitter can be eliminated.

Bandwidth limited modulation format may introduce ISI, which would not be permissible if normal lasers are used as light source. However, in view of the phase incoherent light sources are used, the introduced ISI is additive and can be mitigated efficiently by correlative encoding, convolutional encoding and/or forward error correction (FEC) encoding. Depending upon the encoding scheme used, the appropriate receiver decoder comprises a Viterbi, maximum likelihood sequence estimation (MLSE) and/or FEC decoder. Alternatively, one can also use a timing jitter tolerant detection scheme to mitigate the effect of timing jitter. Such a scheme is described in more detail in commonly assigned U.S. patent application Ser. No. 11/365,254 (Attorney Docket No. 127717), filed Mar. 3, 2006, which is incorporated herein by reference in its entirety.

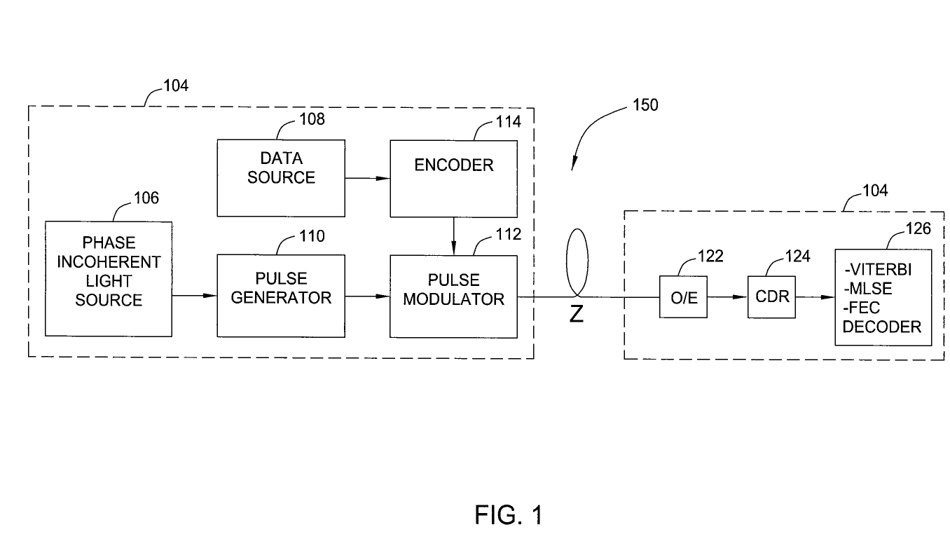

FIG. 1 depicts a block diagram of an exemplary embodiment of an optical communications system in accordance with the invention. Specifically, the optical communications system 100 of FIG. 1 comprises a long haul, high bitrate optical communications system comprising a transmitter 102, an optical communications link 150, and a receiver 104. The transmitter 102 illustratively comprises an incoherent light source 106, a pulse generator 110, a pulse modulator 112, a data source 108, and an encoder 114.

The incoherent light source 102 provides light having a relatively stable intensity level (i.e., an intensity noise similar to that of laser light) and a relatively unstable phase coherence. The incoherent light source 102 may comprise any of chaotic laser light source, a thermal-like light source, and/or an intensity-squeezed light source and the like. The incoherent light source 102 operates to produce light at a predefined transmission wavelength, which is then coupled to the pulse generator 110 to generate thereby a pulse train. For example, a train of optical pulses may be produced having a repetition rate of 10 GHz and a duty cycle of 33% (pulse full width half maximum (FWHM) of 33 ps).

The pulse modulator 112 modulates the optical pulse train in accordance with an output of the encoder 114. The encoder 114 encodes data from the data source 108 in a standard manner to produce an encoded data stream for use by the pulse modulator. The encoder 114 comprises, illustratively, a correlative/convolution encoder employing forward error correction (FEC). The output of the pulse modulator 112 is launched into the optical communications link 150.

The optical communications link 150 has, illustratively, a relatively long length Z and tends to impart errors to an optical signal passing there through via dispersion, nonlinearity and other error sources.

The receiver 104 comprises, illustratively, an optical to electrical (O/E) converter 122 for processing a received optical signal, a clock data recovery (CDR) circuit 124 for recovering timing information from the processed signal, and a decoder 126 for recovering data from the processed signal. The decoding technique utilized in the receiver 104 is selected cooperate with the encoding technique of the transmitter 102. For example, the decoder 126 may comprise a Viterbi decoder employing maximum likelihood sequence estimation (MLSE) and FEC. Other receiver configurations are suitable for use within the context of the present invention.

The above-describe transmitter/receiver configuration utilizes correlative/convolutional encoding and Viterbi/MLSE decoding since this coding/decoding technique is well adapted to reduce error caused by additive ISI. Other coding/decoding techniques may also be used within the context of the present invention. Generally speaking, the technique selected is preferable adapted to address the types of errors that tend to be present when a phase incoherent source is used.

In one embodiment of the invention, the functions of the light source 106 and modulator 112 are combined by using a directly modulated light source, such as a directly modulated phase incoherent laser.

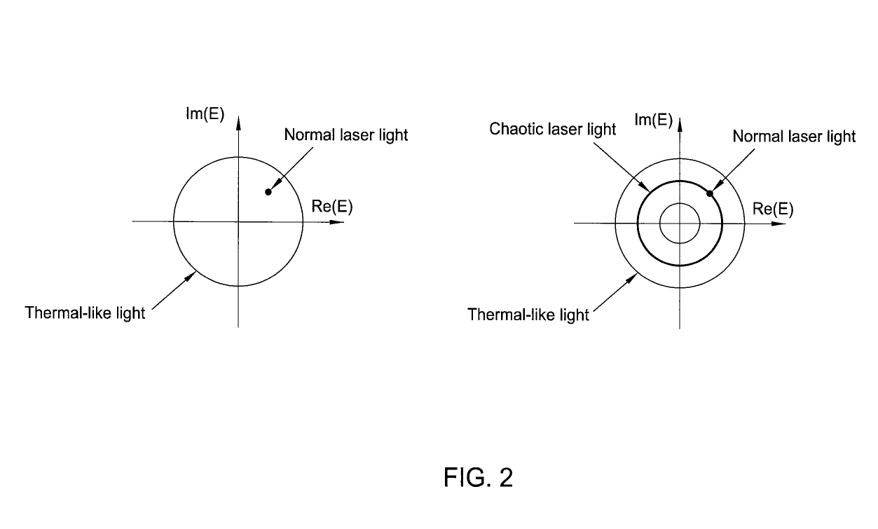

FIG. 2 graphically depicts electrical fields associated with thermal-like light, normal (coherent) laser light, and chaotic laser light. Thermal-like light may be provided by, for example, ASE or LED sources and is phase incoherent but has a large intensity noise, as illustrated by the thick ring in the quadrature plane. Normal laser light has well defined phase and much smaller intensity noise, as illustrated by the finite size dot in the plane. Chaotic laser light, as shown on the right in comparison with the other two types of light sources, is phase incoherent but has the intensity noise similar to that of laser light.

The use of the incoherent light source (due to the lack of phase coherence) provides a random instantaneous lasing frequency, yet the photon statistics is approaching the normal lasing light. Chaotic lasers, random lasers and the like provide a light field that is essentially lasing simultaneously in a large number of coupled spatial modes.

In one embodiment of the invention, a method is provided for reducing inter-symbol interference (ISI) in a fiber optic communication system normally imparting fiber dispersion and nonlinearity errors to communicated optical signals. The method generally comprises adapting an optical source to provide a relatively phase incoherent, low intensity noise optical signal, the optical signal being modulated according to a data stream to produce a modulated optical signal for transmission; and applying error correction adapted to reduce random intensity noise errors and timing jitter errors. The optical source may comprise a non-modulating or self modulating, phase incoherent, low intensity noise optical signal source.

The invention advantageously reduces the total costs associated with an optical communications system by adapting system operation to decrease an error component (ISI) that is relatively expensive to correct at the expense of increasing error components that are relatively inexpensive to correct (random intensity noise errors and timing jitter errors).

Although various embodiments which incorporate the teachings of the present invention have been shown and described in detail herein, those skilled in the art can readily devise many other varied embodiments that still incorporate these teachings.

What is claimed is:

1. Apparatus adapted for use in a high bit rate, long haul optical communication system, comprising:
a modulator, for intensity modulating a phase incoherent, low intensity noise optical signal according to an encoded data stream to produce a modulated optical signal, whereby the modulated optical signal exhibits random intensity noise errors and timing jitter errors when propagated through a long haul optical transmission medium.

2. The apparatus of claim 1, further comprising a light source for providing the phase incoherent, low intensity noise optical signal.

3. The apparatus of claim 2, wherein the light source comprises a chaotic laser source.

4. The apparatus of claim 2, wherein the light source comprises a thermal-like light source.

5. The apparatus of claim 2, wherein the light source comprises an intensity squeezed light source.

6. The apparatus of claim 1, wherein modulator comprises a directly modulated phase incoherent laser.

7. The apparatus of claim 1, wherein the modulated optical signal is adapted for propagation to a receiver having processing circuitry adapted to reduce random intensity noise errors and timing jitter errors.

8. The apparatus of claim 1, wherein the modulator comprises one of a correlative modulator and a Viterbi modulator.

9. The apparatus of claim 1, wherein the modulator comprises a self modulating optical source.

10. The apparatus of claim 1, further comprising:
a correlative convolutional encoder for producing the encoded data stream.

11. The apparatus of claim 10, wherein the encoder utilizes forward error correction (FEC).

12. A transmitter adapted for use in a high bit rate, long haul optical communications system, the transmitter comprising:
a light source for providing a phase incoherent, low intensity noise optical signal;
a modulator, for modulating the optical signal according to a data stream to produce a modulated optical signal exhibiting random intensity noise a timing jitter errors; and
means for reducing the random intensity noise and timing jitter errors.

13. A method for reducing inter-symbol interference (ISI) in a fiber optic communication system imparting fiber dispersion and nonlinearity errors to communicated optical signals, the method comprising:
adapting an optical source to provide a relatively phase incoherent, low intensity noise optical signal, the optical signal being modulated according to a data stream to produce a modulated optical signal for transmission; and
applying error correction adapted to reduce random intensity noise errors and timing jitter errors.

14. The method of claim 13, wherein the step of adapting comprises replacing a coherent laser source with a chaotic laser source.

15. The method of claim 13, wherein the step of adapting comprises replacing a coherent laser source with a thermal-like light source.

16. The method of claim 13, wherein the step of adapting comprises replacing a coherent laser source with an intensity squeezed light source.

17. A method for reducing inter-symbol interference (ISI) in a fiber optic communication system imparting fiber dispersion and nonlinearity errors to communicated optical signals, the method comprising:
determining an ability of the fiber optic communication system to correct random intensity noise errors and timing jitter errors in an optical signal provided thereto;
adapting optical transmitter operation in a manner tending to reduce ISI at the expense of increasing intensity noise errors and timing jitter errors in the optical signal provided thereto; wherein
said adapting comprises using a light source providing a relatively phase incoherent, low intensity noise optical signal, the optical signal being modulated according to a data stream to produce a modulated optical signal for transmission.

18. The method of claim 17, wherein the light source comprises any of a chaotic laser source, an intensity squeezed light source and a thermal-like light source.

19. The method of claim 17, wherein the modulated optical signal is adapted for propagation to a receiver having processing circuitry adapted to reduce random intensity noise errors and timing jitter errors.

20. The method of claim 17, wherein the modulated optical signal is produced using any of a correlative modulator and a Viterbi modulator.
